(19) United States
(12) Patent Application Publication
(10) Pub. No.: US 2020/0067714 A1
(43) Pub. Date: Feb. 27, 2020

(54) BLOCKCHAIN BASED SYSTEM TO PERFORM A TRANSACTION AND METHOD THEREOF

(71) Applicant: VINOD NAIR, Fremont, CA (US)

(72) Inventor: VINOD NAIR, Fremont, CA (US)

(21) Appl. No.: 16/242,183

(22) Filed: Jan. 8, 2019

Related U.S. Application Data
(60) Provisional application No. 62/721,625, filed on Aug. 23, 2018.

(51) Int. Cl. H04L 9/32; H04L 9/06; H04W 12/08; G06Q 20/12

(52) U.S. Cl. CPC H04L 9/3247; H04L 9/0618; H04L 2209/38; G06Q 20/12; H04W 12/08

(57) ABSTRACT

According to an aspect of the present disclosure, a computing system to facilitate the interaction of a group of buyers and a group of sellers through a transaction network comprises a transceiver to communicate with a distributed blockchain computer system that includes multiple computing nodes, each computing node configured to store a copy, or a portion thereof, of a blockchain of the distributed blockchain computer system; a database to store a plurality of demand blocks as the blockchain, where each of the plurality of demand blocks stores information of transaction of at least a product; and processor to receive a product request from a buying entity that comprises information of transaction of the product requested by said buying entity, create a demand block based on information of the requested product and enable the one or more buying entities and the one or more selling entities to cryptographically validate the created demand block to link the demand block to a prior block of the blockchain.

### CROSS REFERENCE TO RELATED APPLICATIONS

This application claims priority on U.S. Provisional Patent Application No. 62/721,625, entitled “BLOCKCHAIN-BASED CROWDSOURCED FILTERING AND MARKING SPAM EMAILS”, filed on Aug. 23, 2018, which is incorporated by reference herein in its entirety and for all purposes.

### TECHNICAL FIELD

The present invention relates to a system to facilitate the interaction of a group of buyers and a group of sellers for negotiating improved terms for products and services being purchased over the internet and more specifically to systems and methods for facilitating buying products and services via a blockchain based platform.

### BACKGROUND

In the present scenario of market conditions, sellers decide what to make, how to make it, where to make it, what ingredients to use, and how it will be serviced. Using power of the Internet and social media, sellers then spend money to haunt their products on to consumers. The winning seller(s) are the ones with the most marketing muscle.

Secondly, sellers in the market place have formed quasi conglomerates within the legal framework of anti-trust laws have found ways to unduly gain market advantages to influence and control the market, taking away the balance of demand and supply in a market place destroying the “perfect competition”. In the pursuit of money, businesses have destroyed society, humanity, the environment, and most importantly the pursuit of happiness. The king of market economy is the consumer all kings are broke and unhappy. The market produces toys of pleasure but no true innovations to make the world a better place or to create true happiness. The sole motivation for the seller is the pursuit of money.

Thirdly, large internet companies have made money invading consumer privacy. Consumers do not realize that they have given away the power of demand in exchange for free internet services. Most of the large internet companies sell consumer patterns to sellers, who in turn use the information to further their objectives. Sellers have all the tools to strengthen their market position, but the consumers have only one and are vulnerable. Sellers throw bones at consumers in the form of discount coupons, sale and deals, which we innocent consumers fall for it. The kings (“Consumers”) of the market economy are broke and vulnerable to the driving factors of uneven market conditions influenced by large sellers with undue and unfair advantages.

Due to above mentioned factors, the market is filled with sub-standard products, e.g. toys that have a life of 1 or 2 years. The consumers run after upgrades, which creates unnecessary production of substandard goods and services that serve no purpose. At present, buyers are not given the opportunity to choose amongst different available products due to a lack of complete information about products. For example, organic or non-organic nature of food product, geographic origin of the product, raw material details, etc that could be more important to the buyer than the price of the goods and/or services. There are good sellers in the market with good intentions that are mostly small business, which get crushed by the large players. Furthermore, each seller is not given a chance to offer their goods and/or services based on different selling criteria given by the consumers/buyers. In many instances, sellers with good motives are not even aware of what consumers/buyers consider important buying criteria. Additionally, sellers are sometimes not aware of requisite selling criteria that other sellers might offer consumers/buyers.

For aggregation of demand, a known technique allows at least one seller to sponsor a deal room to aggregate selling goods/services from a plurality of buyers by including a dashboard for allowing the at least one seller to set up price curves, offers, products, customers, and/or customer groups, for example. The dashboard includes a plurality of wizards for configuring such information. Customized price schedules are derived for a product based on buyer profile. However, the known technique does not provide any methodology to secure or validate the buyers and/or products profile so that the product profile and demands from the buyers can be prevented from tampering.

Accordingly, there is a need in the art for a buying and selling platform which provides both buyers and sellers more control in a commercial purchasing transaction and overcomes the above-mentioned drawbacks and others.

### SUMMARY

Embodiments of the present disclosure relate to systems and methods for facilitating buying products and services over trading platform via a blockchain based platform.

An aspect of the present disclosure relates to a computing system to facilitate a transaction with respect to a product, the computing system includes a transceiver to communicate with a distributed blockchain computer system that includes multiple computing nodes, each computing node configured to store a copy, or a portion thereof, of a blockchain of the distributed blockchain computer system, wherein each computing node relates to a buying entity of one or more buying entities or a selling entity of one or more selling entities; a database to store a plurality of demand blocks as the blockchain of the distributed blockchain system, where each of the plurality of demand blocks stores information of transaction of one product; and at least one processor to: receive a product request from a buying entity of the one or more buying entities, wherein the product request comprises information of transaction of the product requested by the buying entity; in response to receipt of the product request, create a demand block based on information of transaction of the requested product; and enable any or a combination of the one or more buying entities and the one or more selling entities to cryptographically validate the created demand block to link the demand block to a prior block of the blockchain of the distributed blockchain computer system.

According to an embodiment, the demand block provides information of historical communication between the one or more buying entities and the one or more selling entities with regard to the product.

According to an embodiment, information of the product requested by the buying entity comprises any or a combination of attributes of the said product, quantity value of the product, selling price of the product, and price points varying as a function of quantity value of the product.

According to an embodiment, wherein the demand block is linked to at least one buying entity or at least one selling entity through a corresponding private cryptographic key.

According to an embodiment, addition of the demand block increases difficulty of tampering with information of plurality of prior demand blocks of the blockchain.

According to an embodiment, the product request includes attributes of manufacturing and origin of the product.

According to an embodiment, the one or more selling entities analyses market demands of the one or more buying entities based on the blockchain of demand blocks.

According to an embodiment, the product pertains to such as electronic items, fuel real-estate rental property etc.

Another aspect of the present disclosure relates to a method to facilitate a transaction with respect to a product, said method including: receiving, by one or more processors via a transceiver, a product request from a buying entity of one or more buying entities, wherein the product request comprises information of transaction of the product requested by said buying entity, and wherein the transceiver communicates with a distributed blockchain computer system that includes multiple computing nodes, each computing node configured to store a copy, or a portion thereof, of a blockchain of the distributed blockchain computer system such that each computing node relates to a buying entity of the one or more buying entities or a selling entity of one or more selling entities; in response to receipt of the product request, creating, by the one or more processors, a demand block based on information of transaction of the requested product; and enabling, by the one or more processors, any or a combination of the one or more buying entities and the one or more selling entities to cryptographically validate the created demand block to link the demand block to a prior block of the blockchain of the distributed blockchain computer system, wherein a plurality of demand blocks is stored in a database as the blockchain of the distributed blockchain computer system so that each of the plurality of demand blocks stores information of one product.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a simplified network architecture in which aspects of the present invention can be implemented in accordance with an embodiment of the present invention.

FIG. 2 illustrates exemplary functional components of a computing system in accordance with an embodiment of the present invention.

FIG. 3 illustrates and exemplary working of the computing system in combination of the distributed blockchain computer system in accordance with an embodiment of the present disclosure.

FIG. 4 is a high-level flow diagram indicating a process for creation of demand block in a blockchain to facilitate a transaction in accordance with an embodiment of the present invention.

FIG. 5 illustrates an exemplary computer system in which or with which embodiments of the present invention may be utilized.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure Importantly, such phrases do not necessarily refer to the same embodiment.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

Embodiments of the present disclosure relate to systems and methods for facilitating buying products and services via a blockchain based platform.

An aspect of the present disclosure relates to a computing system to facilitate a transaction over trading platformwith respect to a product, the computing system includes a transceiver to communicate with a distributed blockchain computer system that includes multiple computing nodes, each computing node configured to store a copy, or a portion thereof, of a blockchain of the distributed blockchain computer system, wherein each computing node relates to a buying entity of one or more buying entities or a selling entity of one or more selling entities; a database to store a plurality of demand blocks as the blockchain of the distributed blockchain system, where each of the plurality of demand blocks stores information of transaction of one product; and at least one processor to: receive a product request from a buying entity of the one or more buying entities, wherein the product request comprises information of transaction of the product requested by the buying entity; in response to receipt of the product request, create a demand block based on information of transaction of the requested product; and enable any or a combination of the one or more buying entities and the one or more selling entities to cryptographically validate the created demand block to link the demand block to a prior block of the blockchain of the distributed blockchain computer system.

According to an embodiment, the demand block provides information of historical communication between the one or more buying entities and the one or more selling entities with regard to the product.

According to an embodiment, information of the product requested by the buying entity comprises any or a combination of attributes of the said product, quantity value of the product, selling price of the product, and price points varying as a function of quantity value of the product.

According to an embodiment, wherein the demand block is linked to at least one buying entity or at least one selling entity through a corresponding private cryptographic key.

According to an embodiment, addition of the demand block increases difficulty of tampering with information of plurality of prior demand blocks of the blockchain.

According to an embodiment, the product request includes attributes of manufacturing and origin of the product.

According to an embodiment, the one or more selling entities analyses market demands of the one or more buying entities based on the blockchain of demand blocks.

According to an embodiment, the product pertains to real-estate property.

Another aspect of the present disclosure relates to a method to facilitate a transaction with respect to a product, said method including: receiving, by one or more processors via a transceiver, a product request from a buying entity of one or more buying entities, wherein the product request comprises information of transaction of the product requested by said buying entity, and wherein the transceiver communicates with a distributed blockchain computer system that includes multiple computing nodes, each computing node configured to store a copy, or a portion thereof, of a blockchain of the distributed blockchain computer system such that each computing node relates to a buying entity of the one or more buying entities or a selling entity of one or more selling entities; in response to receipt of the product request, creating, by the one or more processors, a demand block based on information of transaction of the requested product; and enabling, by the one or more processors, any or a combination of the one or more buying entities and the one or more selling entities to cryptographically validate the created demand block to link the demand block to a prior block of the blockchain of the distributed blockchain computer system, wherein a plurality of demand blocks is stored in a database as the blockchain of the distributed blockchain computer system so that each of the plurality of demand blocks stores information of one product.

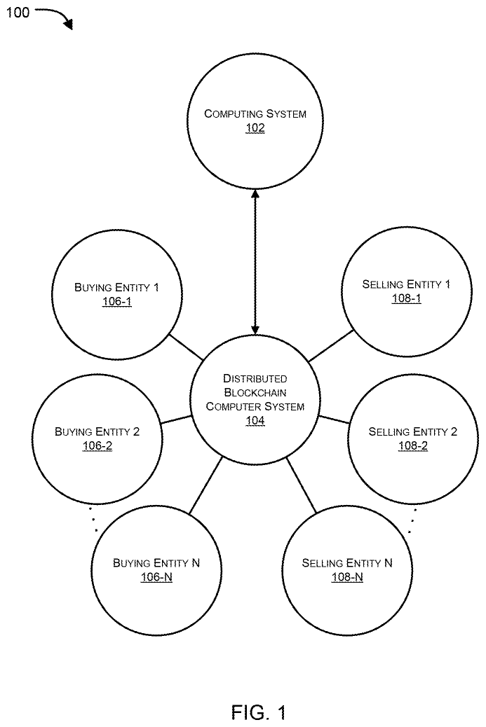

FIG. 1 illustrates a simplified network architecture 100 in which aspects of the present invention can be implemented in accordance with an embodiment of the present invention.

Embodiments of the present disclosure provide a multiple criterion buying and selling system and method using blockchain based platform. Those skilled in the art would appreciate that the blockchain technology has foundation for distributed ledgers and offers an innovative platform for a new decentralized and transparent transaction process in buying and selling of products and services.

According to an aspect, a computing system 102 can communicate with a distributed blockchain computer system 104 that can include multiple computing nodes from buying entities 106-1, 106-2 . . . 106-N (collectively referred to as buying entities 106-1, 106-2, 106-N and individually referred to as buying entity 106, hereinafter) as well as from selling entities 108-1, 108-2 . . . 108-N (collectively referred to as selling entities 108-1, 108-2, 108-N and individually referred to as selling entity 108, hereinafter). The distributed blockchain computer system 104 can store plurality of demand blocks, where each demand block is associated with complete information of a product. The computing system 102 can receive new data information of product requests from buying entities 106 that can be added to the demand block. A match can be identified between information of product requests from potential selling entities 108 and demand hashes from buying entities 106 associated with the demand block.

Those skilled in the art would appreciate that the inherent characteristics of the distributed blockchain computer system 104 enhance confidence and trust of buying entities 106 through transparency and traceability within any transaction of data, goods, and available products resources. The potential benefit of such a methodology is to receive real-time available product data details from selling entities 108 associated with selling goods or services such that the buying entities could gain access to complete information about where the product originates, raw materials of the product, specific supplier information, history of merchant sellers or more. Buying entities 106 can be in a position to ask or demand or even dictate what should be made, how it should be made, how it should be serviced so as to create an optimal balance of economics of business with social and humanitarian aspects. The distributed blockchain computer system 104 can allow all participants in a given system to have access to information about what went into producing and order a given product. The distributed blockchain computer system 104 could be leveraged by buying entities 106 to see how quickly a given product has been received and what type of feedback is available so the buying entities 106 can more easily make best choice by comparing available information in the blockchain database.

According to an embodiment, the computing system 102 can provide a virtual forum to facilitate electronic communication between buyers and sellers. The blockchain of the distributed blockchain computing system is a data structure that can store a list of complete information of product transactions as a distributed electronic ledger that records transactions between sellers and desired buyers. [A]. The transactions can be bundled into blocks termed as demand blocks and every block refers back to or is linked to a prior block in the block chain. Computer nodes from selling entities 108 and buying entities 106 can maintain the blockchain and can cryptographically validate each new demand block and thus the transactions contained in the corresponding demand block. Accordingly, once a demand block refers to a prior demand block, it becomes difficult to modify or tamper with the information of complete products data (e.g., the transactions) contained therein. This is because even a small modification to the information will affect the hash value of the entire demand block. Also, each additional demand block increases the difficulty of tampering with the contents of an earlier demand block. Thus, even though the contents of a blockchain may be available for viewing, they become practically immutable.

In an aspect, computing system 102 can provide a virtual forum to facilitate electronic communication between buying entities 106 and selling entities 108. The demand block contains real-time complete information of products data that include details of buying and selling of products and services for buying entities 106 and its implications range from simple products development tracking, supplier information, compliance and transparency, better tracking of orders to the buying entities 106, reduction in attempted fraud/manipulation of products etc.

In an aspect, the present disclosure provides real-time feedback from buying entities 106 to influence the market on what to make, how to make where to make how to distribute in a manner that can create a perfect competition leading creation of right product by right selling entities 108 that are spread out evenly to prevent undue market advantages for selling entities 108. The demand block can be in the form of block of consumer demands that governs what the market really wants. The demand block can drive the market by connecting buying entities 106 together on a platform, so they can now influence the market. Hence, the present blockchain based system and methods provide greater trust by buying entities 106 i.e. by knowing available information data on demand block that buying entities know a multitude of variables (place, time, item, company history, past products details) and different offer types provided by selling entities 108, they are more likely to develop a trust relationship with a given selling entity 108.

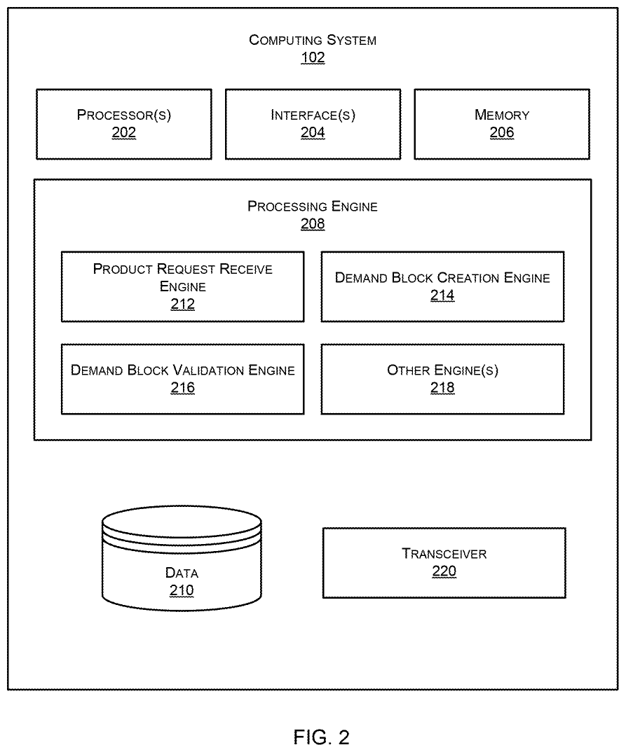

FIG. 2 illustrates exemplary functional components of a computing system 102 in accordance with an embodiment of the present invention.

As illustrated, the computing system 102 can include one or more processor(s) 202. The processor(s) 202 can be implemented as one or more microprocessors, microcomputers, microcontrollers, digital signal processors, central processing units, logic circuitries, and/or any devices that manipulate data based on operational instructions. Among other capabilities, the processor(s) 202 are configured to fetch and execute computer-readable instructions stored in a memory 206 of the computing system 102. The memory 206 can store one or more computer-readable instructions or routines, which may be fetched and executed to create or share the data units over a network service. The memory 206 can include any non-transitory storage device including, for example, volatile memory such as RAM, or non-volatile memory such as EPROM, flash memory, and the like. In an example embodiment, the memory 206 may be a local memory or may be located remotely, such as a server, a file server, a data server, and the Cloud.

The computing system 102 can also include one or more interface(s) 204. The interface(s) 204 may include a variety of interfaces, for example, interfaces for data input and output devices, referred to as I/O devices, storage devices, and the like. The interface(s) 204 may facilitate communication of the computing system 102 with various devices coupled to computing system 102. The interface(s) 204 may also provide a communication pathway for one or more components of the computing system 102. Examples of such components include, but are not limited to, processing engine 208 and database 210.

The processing engine 208 can be implemented as a combination of hardware and software or firmware programming (for example, programmable instructions) to implement one or more functionalities of the engine 208. In the examples described herein, such combinations of hardware and software or firmware programming may be implemented in several different ways. For example, the programming for the engine may be processor executable instructions stored on a non-transitory machine-readable storage medium and the hardware for the engine 208 may include a processing resource (for example, one or more processors), to execute such instructions. In the examples, the machine-readable storage medium may store instructions that, when executed by the processing resource, implement the engine 208. In such examples, the computing system 102 can include the machine-readable storage medium storing the instructions and the processing resource to execute the instructions, or the machine-readable storage medium may be separate but accessible to computing system 102 and the processing resource. In other examples, the processing engine 208 may be implemented by electronic circuitry. The database 210 can include data that is either stored or generated as a result of functionalities implemented by any of the components of the processing engine 208.

In an example, processing engine 208 can include a product request receive engine 212, a demand block creation engine 214, a demand block validation engine 216 and other engine(s) 218. Other engine(s) 218 can implement functionalities that supplement applications or functions performed by computing system 102 or processing engine 208.

In an example, the computing system 102 can include a transceiver 220 to communicate with the distributed blockchain computer system that includes multiple computing nodes. Each computing node can relate to a buying entity or a selling entity and can be configured to store a copy, or a portion thereof, of a blockchain of the distributed blockchain computer system.

In an aspect, database 210 can intermittently or permanently store a plurality of demand blocks as the blockchain of the distributed blockchain system, where each of the plurality of demand blocks can store information of transaction of one product.

In an aspect, the product request receive engine 212 can receive a product request from a buying entity of the one or more buying entities. The product request can include information of transaction of the product requested by the buying entity for example, attributes of a product, a quantity value, price for which the associated sellers can sell a product at particular details, price points varying as a function of a quantity of the products, and the like.

In an aspect, the demand block creation engine 214 can create a demand block in the blockchain of the distributed blockchain computer system based on information of the requested product such that the created demand block is linked to a prior block of the blockchain.

In an aspect, the demand block validation engine 216 enables any or a combination of the one or more buying entities and the one or more selling entities to cryptographically validate the created demand block. Further, the created demand block can be linked to at least one buying entity or at least one selling entity through a corresponding private cryptographic key.

Those skilled in the art would appreciate that the demand block can provide real time complete information and information of historical communication between the buying entities and the selling entities with regard to the product. Further, information of the product requested by the buying entity can include attributes of the said product, quantity value of the product, selling price of the product, price points varying as a function of quantity value of the product, and the like. The product request also includes attributes of manufacturing and origin of the product.

It would further be appreciated, the addition of the demand block increases difficulty of tampering with information of plurality of prior demand blocks of the blockchain. Also, based on the blockchain of the demand blocks, the selling entities can analyse market demands of the buying entities.

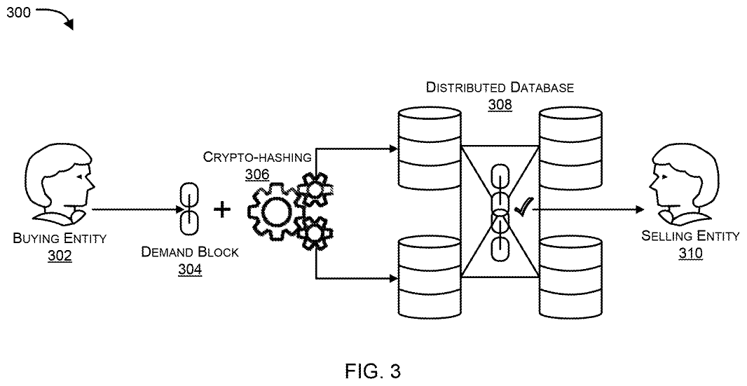

FIG. 3 illustrates and exemplary working 300 of the computing system in combination of the distributed blockchain computer system in accordance with an embodiment of the present disclosure.

In context of the present example, a buying entity 302 raises a product request that includes information of transaction of the product requested by the buying entity. This information includes complete information of the product that the buying entity intents to purchase from a selling entity 310. Based on information of transaction of the requested product a demand block 304 is created. Further, cryptographic hashing 306 if performed to seal the demand block with a lock. The demand block is then transmitted to all computing nodes of the distributed blockchain computer system so that every computing node validates the demand block. The demand block becomes part of the blockchain of distributed database 308 when the computing modes validate if the lock on the demand block is correct. Thus, the demand block becomes part of the blockchain and cannot be altered in any way.

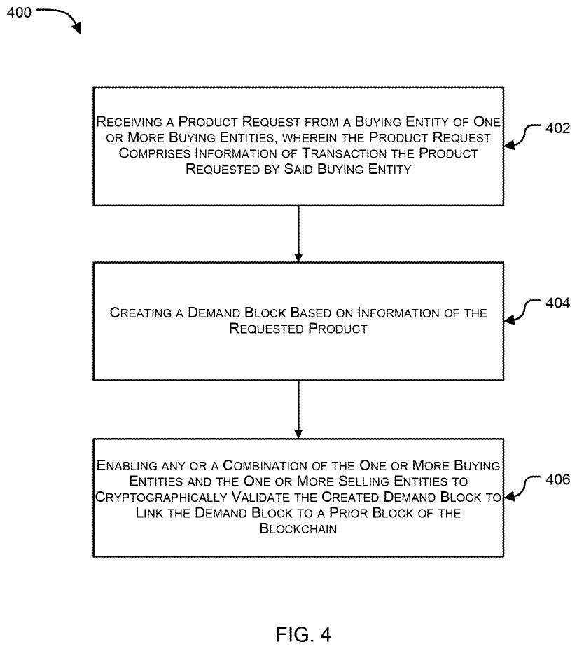

FIG. 4 is a high-level flow diagram indicating a process for creation of demand block in a blockchain to facilitate a transaction in accordance with an embodiment of the present invention.

In context of the present example, the process includes at block 402, receiving, by one or more processors via a transceiver, a product request from a buying entity of one or more buying entities. The product request includes information of transaction of the product requested by the buying entity. The transceiver communicates with a distributed blockchain computer system that includes multiple computing nodes, each computing node configured to store a copy, or a portion thereof, of a blockchain of the distributed blockchain computer system such that each computing node relates to a buying entity of the one or more buying entities or a selling entity of one or more selling entities.

The process further includes, at block 404, in response to receipt of the product request, creating, by the one or more processors, a demand block based on information of transaction of the requested product and at block 406, enabling, by the one or more processors, any or a combination of the one or more buying entities and the one or more selling entities to cryptographically validate the created demand block to link the demand block to a prior block of the blockchain of the distributed blockchain computer system. A plurality of demand blocks is stored in a database as the blockchain of the distributed blockchain computer system so that each of the plurality of demand blocks stores information of one product.

In light of the above, those skilled in the art would appreciate that embodiments of the present disclosure provides an advantage to radically alter market conditions by enabling buying entities to influence market by stacking up against selling entities, particularly large selling entities to ensure products and services are right for the consumers and therefore, serves a purpose for greater good of everyone in the market. Furthermore, the technique of demand blocks can connect the buying entity and the selling entity in an unprecedented way balancing market condition. The selling entity can have real-time visibility on what the market wants, when it wants, how it wants, how many, how it should be packed, where it should be made, how much price it will be bear.

According to an example, the embodiments of the present disclosure can be utilized in an instance with respect to rent and home ownership, where private equity firms buying residential homes and apartment complex from small landlords, collectively drive the price. Using embodiments of the present disclosure buying entities can gain insight into markets and influence the market by real-time flow of information. Real-time an internet-based real estate services can be provided that has an integrated property searching service. The real estate service can employ a blockchain based database of real property listings and a user interface permitting buying entities to define points-of-interest. The points-of-interest defined by a particular buying entity can be stored in blockchain database and used to calculate distances to properties selected from the property listings database. In this manner, a user may interactively adjust his search criteria while observing how far the newly identified property listings are from the defined points-of-interest.

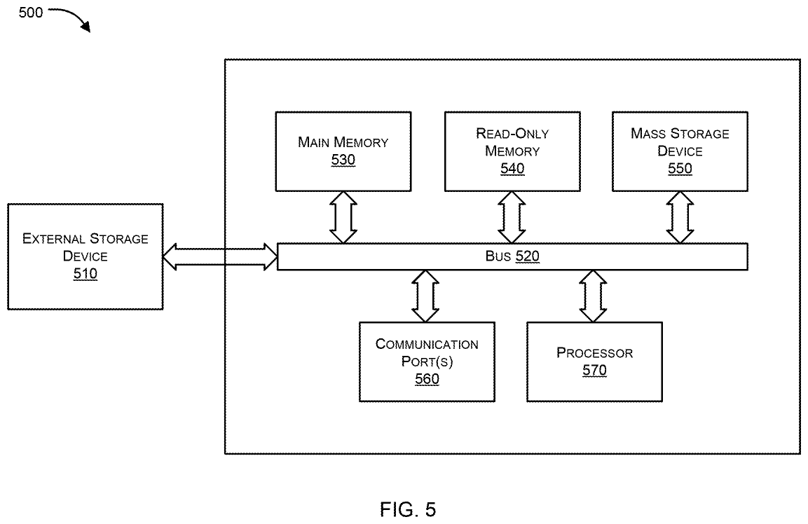

FIG. 5 illustrates an exemplary computer system 500 in which or with which embodiments of the present invention may be utilized.

As shown in FIG. 5, computer system 500, includes an external storage device 510, a bus 520, a main memory 530, a read only memory 540, a mass storage device 550, a communication port 560, and a processor 570.

Those skilled in the art will appreciate that computer system 500 may include more than one processor 570 and communication ports 560. Examples of processor 570 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 570 may include various modules associated with embodiments of the present invention.

Communication port 560 can be any of an RS-232 port for use with a modem based dialup connection, a 10/100 Ethernet port, a Gigabit or 10 Gigabit port using copper or fiber, a serial port, a parallel port, or other existing or future ports. Communication port 560 may be chosen depending on a network, such a Local Area Network (LAN), Wide Area Network (WAN), or any network to which computer system connects.

Memory 530 can be Random Access Memory (RAM), or any other dynamic storage device commonly known in the art. Read only memory 540 can be any static storage device(s) e.g., but not limited to, a Programmable Read Only Memory (PROM) chips for storing static information e.g. start-up or BIOS instructions for processor 570.

Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 520 communicatively couples processor(s) 570 with the other memory, storage and communication blocks. Bus 520 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system.

Optionally, operator and administrative interfaces, e.g. a display, keyboard, and a cursor control device, may also be coupled to bus 520 to support direct operator interaction with computer system. Other operator and administrative interfaces can be provided through network connections connected through communication port 560. External storage device 510 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A computing system to facilitate a transaction with respect to a product, said computing system comprising:
a transceiver to communicate with a distributed blockchain computer system that includes multiple computing nodes, each computing node configured to store a copy, or a portion thereof, of a blockchain of the distributed blockchain computer system, wherein each computing node relates to a buying entity of one or more buying entities or a selling entity of one or more selling entities;
a database to store a plurality of demand blocks as the blockchain of the distributed blockchain system, where each of the plurality of demand blocks stores information of transaction of at least one product; and
at least one processor to:
receive a product request from a buying entity of the one or more buying entities, wherein the product request comprises information of transaction of the product requested by said buying entity;
in response to receipt of the product request, create a demand block based on information of transaction of the requested product; and
enable any or a combination of the one or more buying entities and the one or more selling entities to cryptographically validate the created demand block to link the demand block to a prior block of the blockchain of the distributed blockchain computer system.

2. The computing system of claim 1, wherein the demand block provides information of historical communication between the one or more buying entities and the one or more selling entities with regard to the product.

3. The computing system of claim 1, wherein information of the product requested by the buying entity comprises any or a combination of attributes of the said product, quantity value of the product, selling price of the product, and price points varying as a function of quantity value of the product.

4. The computing system of claim 1, wherein the demand block is linked to at least one buying entity or at least one selling entity through a corresponding private cryptographic key

5. The computing system of claim 1, wherein addition of the demand block increases difficulty of tampering with information of plurality of prior demand blocks of the blockchain.

6. The computing system of claim 1, wherein the product request includes attributes of manufacturing and origin of the product.

7. The computing system of claim 1, wherein the one or more selling entities analyses market demands of the one or more buying entities based on the blockchain of demand blocks.

8. The computing system of claim 1, wherein the product pertains to real-estate property.

9. A method to facilitate a transaction with respect to a product, said method comprising:
receiving, by one or more processors via a transceiver, a product request from a buying entity of one or more buying entities, wherein the product request comprises information of transaction of the product requested by said buying entity, and wherein the transceiver communicates with a distributed blockchain computer system that includes multiple computing nodes, each computing node configured to store a copy, or a portion thereof, of a blockchain of the distributed blockchain computer system such that each computing node relates to a buying entity of the one or more buying entities or a selling entity of one or more selling entities;
in response to receipt of the product request, creating, by the one or more processors, a demand block based on information of transaction of the requested product; and
enabling, by the one or more processors, any or a combination of the one or more buying entities and the one or more selling entities to cryptographically validate the created demand block to link the demand block to a prior block of the blockchain of the distributed blockchain computer system, wherein a plurality of demand blocks is stored in a database as the blockchain of the distributed blockchain computer system so that each of the plurality of demand blocks stores information of one product.

10. The method of claim 9, wherein the demand block provides information of historical communication between the one or more buying entities and the one or more selling entities with regard to the product.

11. The method of claim 9, wherein information of the product requested by the buying entity comprises any or a combination of attributes of the said product, quantity value of the product, selling price of the product, and price points varying as a function of quantity value of the product.

12. The method of claim 9, wherein the demand block is linked to at least one buying entity or at least one selling entity through a corresponding private cryptographic key.

13. The method of claim 9, wherein addition of the demand block increases difficulty of tampering with information of plurality of prior demand blocks of the blockchain.

14. The method of claim 9, wherein the product request includes attributes of manufacturing and origin of the product.

15. The method of claim 9, wherein the one or more selling entities analyses market demands of the one or more buying entities based on the blockchain of demand blocks.

16. The method of claim 9, wherein the product pertains to real-estate property.
